(19) United States
(12) Patent Application Publication
(10) Pub. No.: US 2024/0314178 A1
(43) Pub. Date: Sep. 19, 2024

(54) METHOD AND SYSTEM IN 3GPP NETWORKS FOR REPORTING OF VOWIFI CALLS OVER UNTRUSTED NON-3GPP ACCESS

(71) Applicant: TELEFONAKTIEBOLAGET LM ERICSSON (PUBL), Stockholm (SE)

(72) Inventors: Yatin RAJWADHA, Noida (IN); Ankit KULSHRESTHA, Jaipur Rajasthan (IN)

(21) Appl. No.: 18/546,904

(22) PCT Filed: Feb. 20, 2021
(86) PCT No.: PCT/IN2021/050162

§ 371 Date: Aug. 17, 2023

(51) Int. Cl. H04L 65/1016; H04L 65/1104; H04L 65/80

(52) U.S. Cl. CPC H04L 65/1016; H04L 65/1104; H04L 65/80

(57) ABSTRACT

A method of operation in a wireless communication system comprises establishing by a UE over a cellular communications access network, a Quality of Service QoS flow, for an incoming Internet Protocol Multimedia Subsystem (IMS) session. The UE triggers over an untrusted non-3GPP access network, another IMS registration request along with requesting an IP address of the UE. The request includes an internet service provider (ISP) identifier of the untrusted access network. A network node transfers the incoming IMS session to the QoS flow established for the incoming IMS session to the untrusted access network being accessed by the UE. Thereafter, the IMS reports details of calls availed by the UE through the untrusted access network to a remote server.

### TECHNICAL FIELD

The present disclosure relates to communication in 3GPP networks and in particular, relates to Internet Protocol (IP) Multimedia Subsystem (IMS) session continuity, handover. through communication over an untrusted non-3GPP access.

### BACKGROUND

Voice over WiFi (VoWiFi) is a technology that is integrated with the Third Generation Partnership Project (3GPP) core network (e.g., the Evolved Packet Core (EPC) for Long Term Evolution (LTE) or the Fifth Generation Core (5GC) for Fifth Generation (5G) New Radio (NR)). VoWiFi is a complementary technology for, e.g., Voice over LTE (VOLTE) that utilizes Internet Protocol (IP) Multimedia Subsystem (IMS) technology to provide packet voice service that is delivered over WiFi using IP. In 3GPP terminology, VoWiFi is one type of Non-3GPP (N3GPP) access that is integrated with the 3GPP core network.

Non-3GPP Access technologies such as WLAN (WiFi) technologies can connect to the 3GPP core network like EPC (Evolved Packet Core) & 5G core in various ways based on the operator's business models and architectural preferences. VoWiFi stands for Voice over Wi-Fi. VoWiFi is a complementary technology to VOLTE which utilizes IMS technology to provide a packet voice service delivered over IP via a Wi-Fi network. VoWiFi is generally used in absence of operator's network coverage or shallow coverage and for better indoor coverage and faster connectivity.

When a User Equipment (UE) supports Non-3GPP Access technologies and cellular access, the UE may receive a session on the cellular access and desire to initiate handover of the session to Non-3GPP Access technologies such as WLAN. Non-3GPP Interworking Function (N3IWF) is element of the 5G Architecture, responsible for interworking between untrusted non-3GPP networks and the 5G Core. As such, N3IWF supports both N2 and N3 based connectivity to the core, whilst supporting IPsec connectivity towards the device. The N2 Reference interface is between N3IWF and the AMF (Access and Mobility Management Function). N3 Reference point is between the N3IWF and the UPF (User Plane Function).

Trusted Non-3GPP access are generally provided by the carrier grade WiFi Services, which are provided and managed by a mobile network operator by its own. Untrusted Non-3GPP access can be a connection with any ordinary WiFi network hosted by any personal enterprise or a company using some internet service providers (ISP) internet connection. At least an example of the untrusted WiFi network may be home WiFi, coffee shop, etc.

Access and Mobility Function (AMF) in 5G receives all connection and session related information from the User Equipment (UE) and is responsible only for handling connection and mobility management tasks. All messages related to session management are forwarded over the N11 reference interface to the Session Management Function (SMF).

Policy Control Function (PCF) in 5G is a Network Function which provides policy rules for control plane functions. This includes network slicing, roaming and mobility management. The same supports the new 5G QoS policy and charging control functions. Npcf Service-based interface (3GPP Spec TS 23.501) exhibited by PCF which is consumed by other network functions (NFs). Reference point between AMF & PCF is known as N15 reference point. As of today, following services are provided by PCF as mentioned in 3GPP Specs TS 23.501 & TS 23.502:
Npcf_AMPolicyControl
Npcf_SMPolicyControl
Npcf_PolicyAuthorization
Npcf_BDTPolicyControl
Npcf_UEPolicyControl
Npcf_EventExposure

Trusted Non-3GPP access generally provided by operator itself has complete control over the Voice calling and charging of the VoWiFi calls generated by using its own network. Moreover, Trusted Non-3GPP WiFi is completely owned by telecom operator itself and has no partners involved for revenue settlement. Trusted WiFi deployed by Telecom Operator is also known as Carrier WiFi.

Since carrier WiFi (Telco's own WiFi network) cannot be deployed by operator everywhere or to all geographical locations, it becomes essential for the operator to support the Untrusted WiFi network for areas where there is less or no network coverage. Untrusted WiFi network service provider may block the VoWiFi Calls, if the telecom operator is not in agreement or contract with it. Moreover, if such agreement is done with the Untrusted WiFi service provider, then VoWiFi calls over Untrusted network should be reported to Untrusted WiFi service provider. Untrusted WiFi Service provider can also build scenario/use cases where the WiFi Service provider can offer discounts, bonus, royalty points etc., in agreement with telecom operators to its subscribers or users if its network is used to make VoWiFi calls.

In at least current architecture with 4G or 5G, the above facility is not possible, since there is no such mechanism proposed by 3GPP which can identify the Untrusted WiFi Network provider which is used to make Voice over WiFi Calls and reports such VoWiFi Calls to Untrusted WiFi Network Provider in real-time.

There lies at least a need of real-time reporting of VoWiFi usage executed over the untrusted 3GPP network through the 3GPP network communication to an internet service provider associated with the untrusted 3GPP network.

Alternatively, there lies at least a need of real-time reporting of VoWiFi calls to internet service provider by telecom operator to thereby build the trust ecosystem between the two.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

The present subject matter at least facilitates a method of operation in a wireless communication system. The method comprises registering by a UE over a cellular communications access network using a session initiation protocol (SIP) registration request with an incoming Internet Protocol Multimedia Subsystem (IMS) session. Further, method comprises triggering by the UE, over an untrusted non-3GPP access network, another IMS registration request along with requesting an IP address of the UE, said request comprising an internet service provider (ISP) identifier of the untrusted access network. Further, method comprises transferring by a network node the incoming IMS session to the untrusted access network being accessed by the UE. Further, details of calls availed by the UE through the untrusted access network are reported to a remote server by the IMS.

At least based on aforesaid, an untrusted non-3GPP access network is connected to the 5G Core Network via a Non-3GPP Interworking Function (N3IWF). N3IWF acts as a gateway to connect to 5G core for making voice calls over WiFi. Since Untrusted WiFi access is provided over IP, WiFi internet service provided can be easily identified by its Gateway IP connecting to N3IWF. N3IWF will identify the internet provider's IP Address in the incoming request.

After identifying the internet network service provider which is used to make VoWiFi call by the subscriber, N3IWF can induce a network parameter into 5G core which can be forwarded to 5G network functions (NF) which can further used to report real time VoWiFi calls to internet service provider (ISP).

Based on the VoWiFi calls reported in real time to Internet service provider (ISP), discounts can be offered on prepaid internet plans in agreement with the Telco used to make VoWiFi call. In addition to discounts and offer on prepaid internet plans, ISP can also use VoWiFi Calls data for analysis and further identifying the usage trends to create new offers. Moreover, since the VoWiFi calls are reported in real time, it can help create ISP dynamic discount offers also in which discounts will be provided in the real time.

Overall, the present subject matter introduces some enrichments of existing nodes and services-based interface in 5G architecture described in 3GPP release 16. Below points describe the solution in stepwise manner. Steps are arranged in a sequential manner where the first step will start from the 5G access till the last in which call is reported to ISP via IMS:
1) Definition of ISP identifier parameters at N3IWF
2) Passing of ISP identifier parameters from N3IWF to AMF using N2 interface.
3) Policy and Charging (PCC) rules enrichment with new parameters (information names) for Untrusted Non-3GPP Access on PCF
4) PCF change of access type event enriched with ISP Identifier parameter.
5) Subscription of IMS to PCF's “Change of Access Type” Event Notification
6) Real time VoWiFi call reporting to ISP

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a method of operation in a wireless communication system in accordance with an embodiment of the present subject matter;

FIG. 2 illustrates a method of operation by a UE in wireless communication system in accordance with an embodiment of the present subject matter;

FIG. 3 refers a format of ISP identifier parameter defined at Non-3GPP Interworking Function (N3IWF) in accordance with an embodiment of the present subject matter;

FIG. 4 illustrates policy and charging (PCC) rules enrichment with new parameters (information names) for untrusted Non-3GPP Access on PCF in accordance with an embodiment of the present subject matter;

FIG. 5 illustrates communication of change of access type notification to the IMS and real time VoWiFi call reporting to ISP in accordance with an embodiment of the present subject matter; and

FIG. 6 illustrates a sequence/call flow diagram in a stepwise manner in accordance with an embodiment of the present subject matter.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

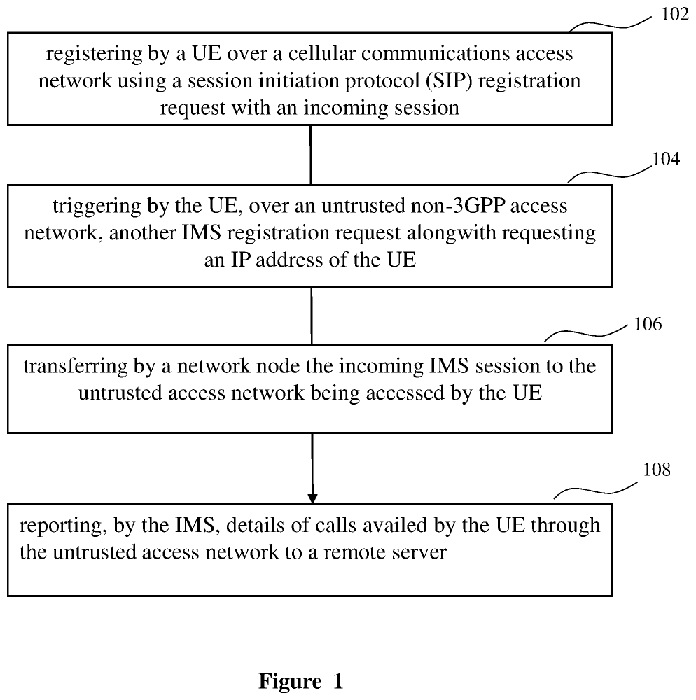

FIG. 1 illustrates a method of operation in a wireless communication system in accordance with an embodiment of the present subject matter.

The method comprises registering (step 102) by a UE over a cellular communications access network using a session initiation protocol (SIP) registration request with an incoming Internet Protocol Multimedia Subsystem (IMS) session. More specifically, the UE establishes over a cellular communications access network, a Quality of Service QoS flow, for an incoming Internet Protocol Multimedia Subsystem (IMS) session. The establishing of the QoS flow comprises establishing by a UE over the cellular communications access network, a first Quality of Service QoS flow, for an incoming Internet Protocol Multimedia Subsystem (IMS) session having QoS requirements, wherein the first QoS flow for the incoming IMS session is associated with a first Internet Protocol (IP) address assigned to the UE for the cellular communications access network by the IMS in response to the session initiation protocol (SIP) registration request. The subscription to the notification of access-change is confirmed by the network node on behalf of the UE based on a subscription request received from the IMS subsequent to the establishment of the first QoS flow for the incoming IMS session.

The method further comprises triggering (104) by the UE, over an untrusted non-3GPP access network, another IMS registration request along with requesting an IP address of the UE, said request comprising an internet service provider (ISP) identifier of the untrusted access network. The triggering by the UE another IMS registration request comprises receiving a second IP address assigned to the UE for said untrusted access network by an interworking function within the network. Based thereupon, the UE triggers over the untrusted non-3GPP access network. UN-WLAN, access network, a second IMS registration request with the second IP address of the UE

In response to the received second IP address of the UE and the ISP identifier, the network node generates the access change notification for the IMS for initiating establishment of a second QoS bearer or QoS flow for the incoming IMS session over the untrusted access network. The second QoS bearer or QoS flow for the incoming IMS session is associated with the second IP address assigned to the UE for the untrusted access network. The initiating establishment of the second QoS bearer or QoS flow for the incoming IMS session over the untrusted access network comprises sending, over the cellular communications access network the SIP message that initiates establishment of the second QoS bearer or QoS flow for the incoming IMS session over the untrusted access network

Further, the method comprises transferring (106) by a network node, the incoming IMS session to the QoS flow established for the incoming IMS session to the untrusted access network being accessed by the UE. The transferring of the incoming IMS session to the untrusted access network comprises transferring the incoming IMS session from the first IP address of the UE associated with the first QoS bearer or QoS flow established for the incoming IMS session over the cellular communications access network to the second IP address of the UE associated with the second QoS bearer or QoS flow established for the incoming IMS session over the untrusted access network.

Further, the method comprises reporting (108), by the IMS, details of calls availed by the UE through the untrusted access network to a remote server. The locating of the remote server by the IMS is based on the ISP identifier through an internet gateway, wherein said remote server corresponds to an internet service provider associated with the untrusted access network. Thereafter, the details related to one or more mobile originated (MO) or mobile terminated (MT) calls availed by the UE through the untrusted access network are reported to the remote server.

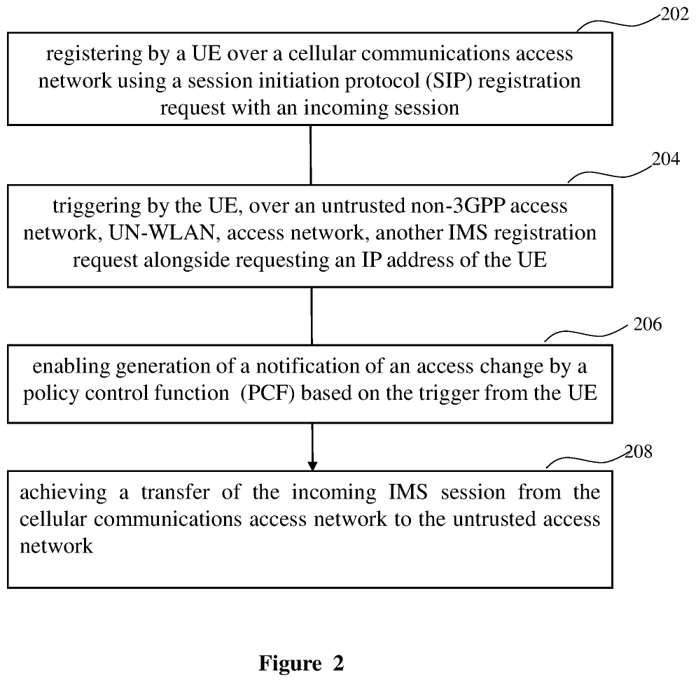

FIG. 2 illustrates a method of operation by a UE in wireless communication system in accordance with an embodiment of the present subject matter.

The method comprises registering (step 202) by a UE over a cellular communications access network using a session initiation protocol (SIP) registration request with an incoming Internet Protocol Multimedia Subsystem (IMS) session. Specifically, the UE establishes over a cellular communications access network, a Quality of Service QoS flow, for an incoming Internet Protocol Multimedia Subsystem (IMS) session. More specifically, the UE establishes over the cellular communications access network, a first Quality of Service QoS flow, for an incoming Internet Protocol Multimedia Subsystem (IMS) session having QoS requirements. The first QoS flow for the incoming IMS session is associated with a first Internet Protocol (IP) address assigned to the UE for the cellular communications access network by the IMS in response to the session initiation protocol (SIP) registration request.

Further, the method comprises triggering (204) triggering by the UE, over an untrusted non-3GPP access network, UN-WLAN, access network, another IMS registration request alongside requesting an IP address of the UE, wherein such request comprises an internet service provider (ISP) identifier of the access network. The triggering by the UE comprises receiving a second IP address assigned to the UE for said untrusted access network by an interworking function within the network. Thereafter, the UE triggers over the untrusted non-3GPP access network, UN-WLAN, access network, an IMS registration request with the second IP address of the UE, said request comprising an internet service provider (ISP) identifier of the access network.

Further, the method comprises enabling generation (206) of a notification of an access change by a policy control function (PCF) based on the trigger from the UE, said notification directed to the IMS based on the IP address of the UE and the ISP identifier for initiating establishment of the incoming IMS session over the untrusted access network. The generation of the access change notification enabled by the UE comprises generation of a notification of an access change directed to the IMS based on the second IP address of the UE and the ISP identifier for initiating establishment of a second QoS bearer or QoS flow for the incoming IMS session over the untrusted access network. The second QoS bearer or QoS flow for the incoming IMS session is associated with the second IP address assigned to the UE for the untrusted access network.

Further, the method comprises achieving (208) a transfer of the incoming IMS session from the cellular communications access network to the untrusted access network. The transferring of the incoming IMS session comprises achieving the transfer of the incoming IMS session from the first IP address of the UE associated with the first QoS bearer or QoS flow established for the incoming IMS session over the cellular communications access network to the second IP address of the UE associated with the second QoS bearer or QoS flow established for the incoming IMS session over the untrusted access network.

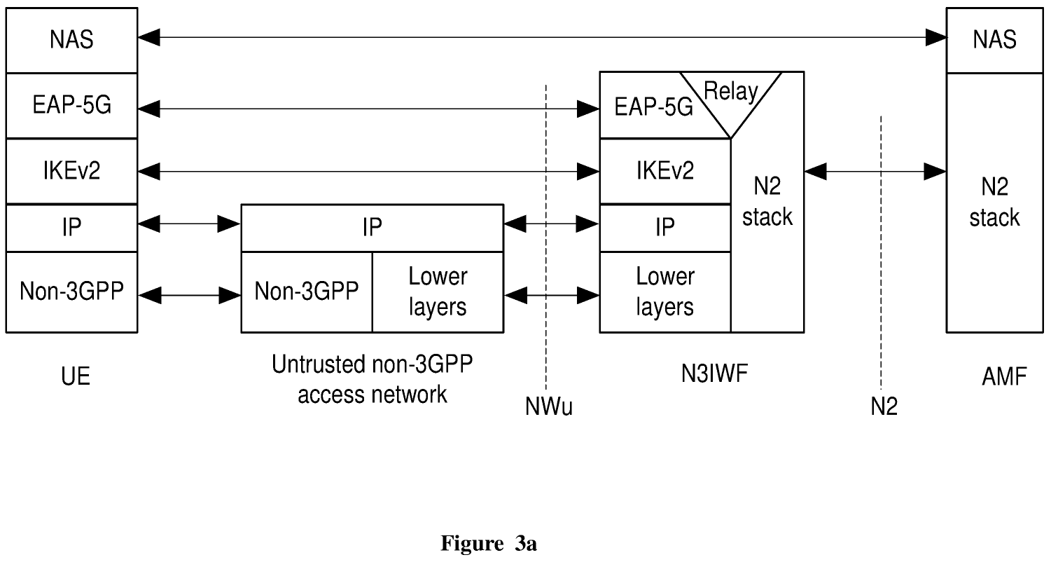

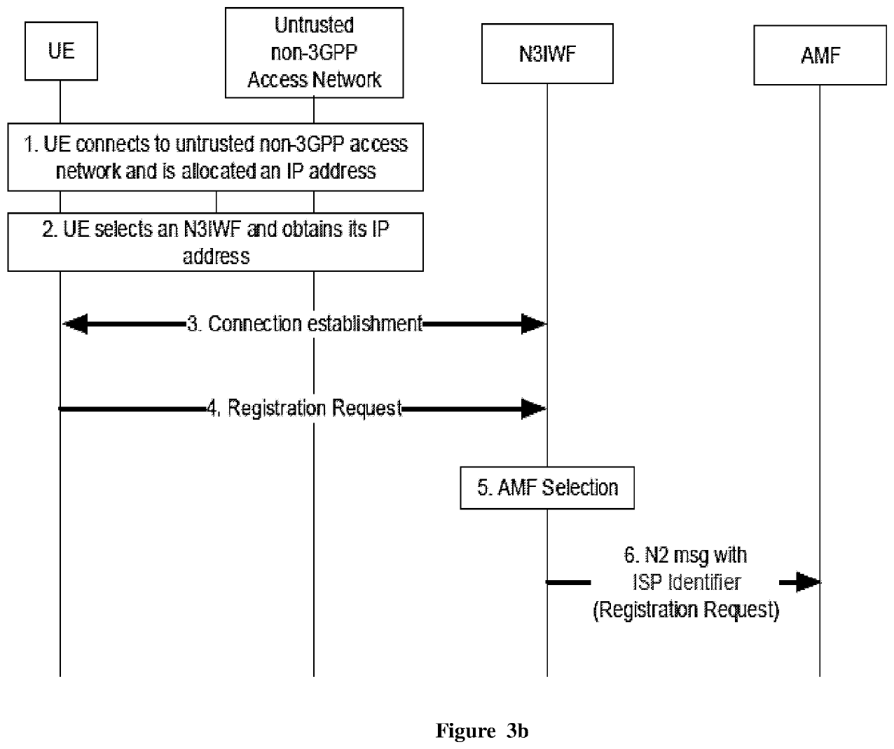

FIG. 3 refers a format of ISP identifier parameter defined at Non-3GPP Interworking Function (N3IWF) and accordingly corresponds to step 104 and 204 of FIG. 1 and FIG. 2, respectively.

A network-entity provides a gateway or interworking function between 3GPP network and non-3GPP network in a wireless communications system. In operation, the entity receives from the UE, over an untrusted non-3GPP access network, UN-WLAN, access network, a connection request. The entity allocates an IP address to the UE for accessing through said untrusted access network. The entity receives from the UE, over the untrusted non-3GPP access network, an IMS registration request from the UE through the second IP address, said IMS registration request comprising an internet service provider (ISP) identifier of the untrusted access network. Thereafter, the entity sends the IMS registration request to a network node with the ISP Identifier for enabling policy association through the untrusted access network.

In accordance with the present subject matter, the interworking function is configured for maintaining an ISP table comprising a mapping between one or more ISP IP addresses and one or more ISP identifiers. The ISP identifier associated with the untrusted access network is identified based on the ISP table. The IMS registration request is sent to the network node by forwarding the identified ISP identifier to an access and mobility function (AMF) node.

In operation, (N3IWF) connects with AMF using N2 interface as described in 3GPP Spec 23.501. User Equipment (UE) connects with the N3IWF via untrusted WiFi Internet service. Communication between UE and N3IWF happens over the TCP/IP, where Gateway end point IP(s) of the ISP is used to connect N3WIF. N3WIF checks for the source IP address of the request from the UE arriving via the ISP gateway.

An ISP mapping between ISP IP Addresses and ISP identifier has been defined in N3WIF that will be configured and maintained as part of telecom operator's business operations. ISP Identifier is a string or data format to uniquely identify the ISP. ISP Identifier is further passed to the 5G core network by N3WIF.

An example for such ISP mapping is shown below as following Table 1

TABLE 1

| | WiFi Internet Service Provider IP |
|---|---|
| ISP Identifier | Address(s) |
| ISP1 | 110.122.12.1, 180.12.56.105 |
| ISP2 | 173.12.110.1 |

To facilitate aforesaid mapping, an ISP can come into agreement with 4G or 5G telecom operator (mobile network operator) by enabling its network to pass its Gateway IP(s) address to the N3WIF. ISP can enable this feature of passing Gateway IP address when request comes for connection to N3WIF node. In IP terminology this approach is known as Network Address Translation (NAT). In other words, Gateway IP can be sent in the request to N3IWF via NAT approach. Moreover, N3IWF will only add ISP identifier in the further request to 5G core network, if IP address for the ISP is configured in it.

As indicated in FIG. 3a, a passing of ISP identifier parameter from N3IWF to AMF using N2 interface has been depicted. N3IWF node connects with 5G AMF over N2 interface. After ISP identifier is determined by N3IWF, it is passed to AMF via N2 interface at the time of registration of UE with AMF. ISP identifier is passed using control plane traffic, since N2 is control plane interface. The representation as shown in FIG. 3a is based on 3GPP spec which shows the protocol stack and IP connectivity from UE till AMF. The same also shows IP connectivity on UE on untrusted non-3GPP access network and N3WIF. IKEv2 protocol comes into action once IP connectivity is established. N3IWF will check for the ISP mapping table introduced in previous step and while sending registration request to AMF using N2 Stack, it will also send the ISP Identifier if found in the N3IWF configuration.

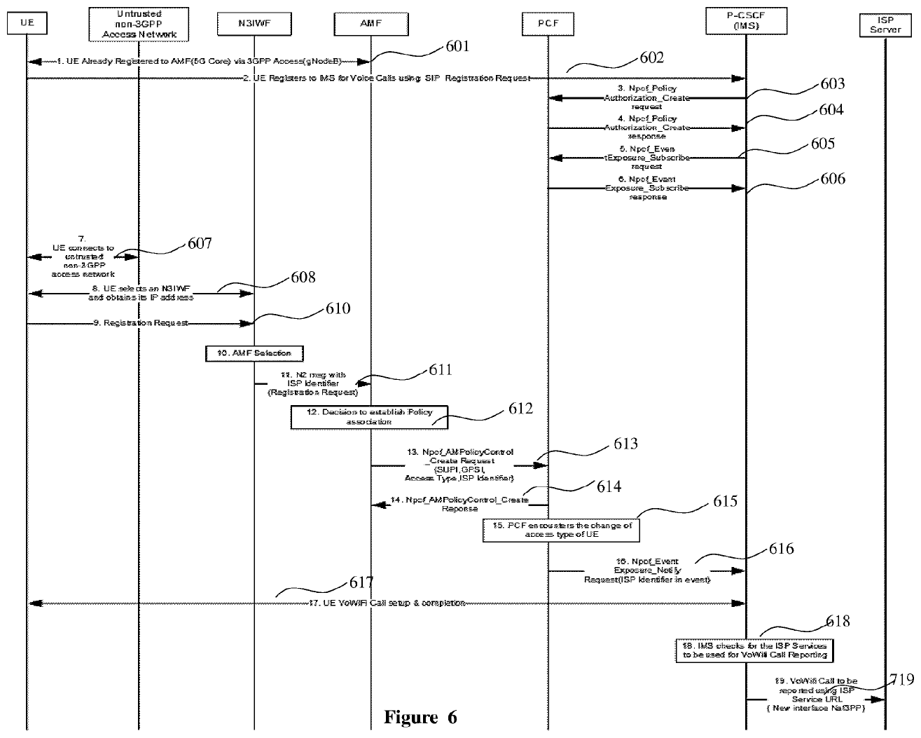

FIG. 3b refers a call flow/sequence diagram in accordance with the steps 104 and 204 of FIG. 1 and FIG. 2 respectively. Especially, the N2 communication between the N3IWF and AMF now comprises the ISP identifier as associated with the untrusted 3GPP network. More specifically, Step 6 in FIG. 3b shows the ISP Identifier passed in the registration request in N2 message from N3IWF to AMF. The overall call flow corresponding to steps 202 till 208 or 102 till 108 have been depicted with respect to a complete call flow depicted at FIG. 6.

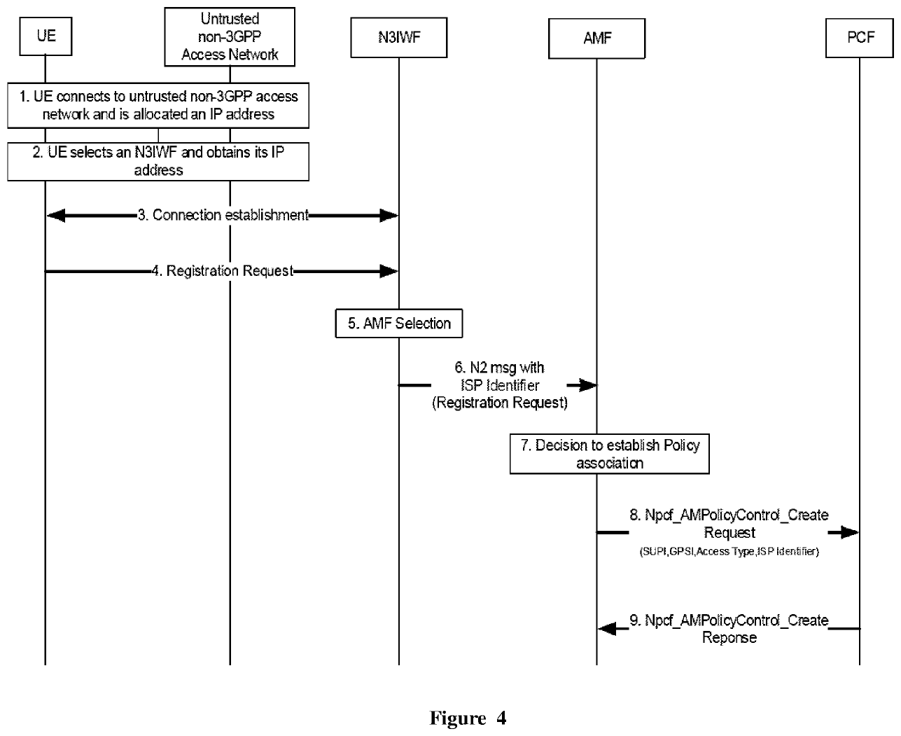

FIG. 4 illustrates policy and charging (PCC) rules enrichment with new parameters (information names) for untrusted Non-3GPP Access on PCF and accordingly corresponds to step 104 and 204 of FIG. 1 and FIG. 2, respectively. Specifically, PCC rules enable creation of a policy association for the access of the UE through the untrusted access network based on a plurality of parameters from UE context and the ISP identifier.

In accordance with 3GPP TS 23.503 clause 6.3.1m, Policy and charging control (PCC) are enriched with more parameters for Untrusted Non-3GPP Access for VoWiFi calls access. In accordance with the present subject matter, additional information names “ISP Identifier” and “VoWiFi Call Reporting” are added in PCC rules as shown in below table 2 as shown below:

TABLE 2

| Information | | |
|---|---|---|
| name | Description | Category |
| Rule identifier | Uniquely identifies the PCC rule for | Mandatory |
| | Untrusted Non 3GPP Access | |
| Untrusted Non- | This part defines information | |
| 3GPP Access | supporting Untrusted Non 3GPP | |
| Control | access, reporting and third party | |
| | discounting | |
| ISP Identifier | ISP identifier is introduced to | Optional |
| | identify the ISP. | |
| VoWiFi Call | Indicates the VoWiFi Calls to be | Optional |
| Reporting | reported to Untrusted network | |
| | provider. | |

The aforesaid additional newly added above policy and charging control (PCC) rules parameters are saved in UDR like state of the art PCC rules parameters. More specifically, the creating of policy association comprises updating a set of policy and charging control (PCC) rules for the access of the UE through the untrusted access network with one or more parameters comprising the ISP Identifier and a VoWiFi Call reporting parameter.

The call flow diagram as depicted in FIG. 4 illustrates the passing of ISP identifier along with other parameters like SUPI, GSPI, Access Type, etc. from UE context. Creation of policy association is requested vide Npcf_AMPolicyControl_Create request to PCF. More specifically, Step 8 in the FIG. 4 illustrates inclusion of ISP Identifier in the Npcf_AMPolicyControl_Create request sent by AMF to PCF to create the policy association.

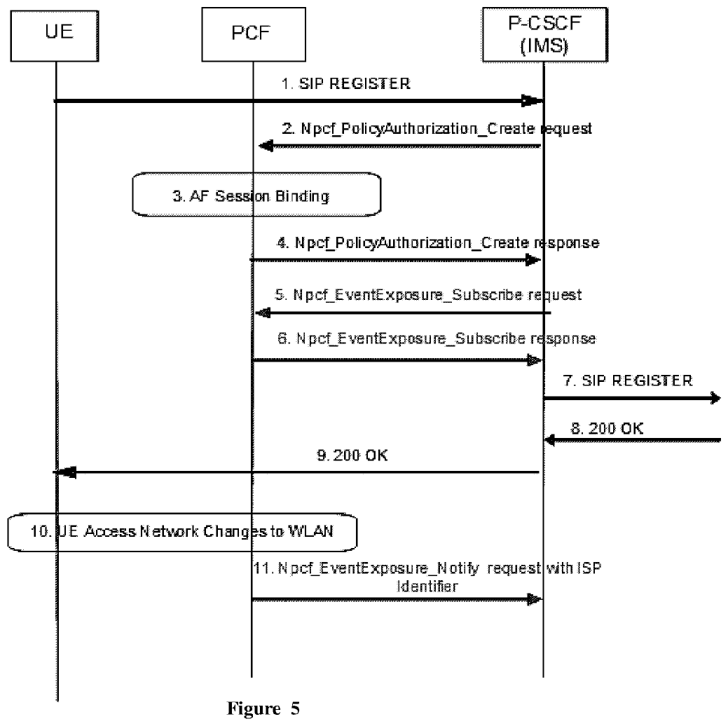

FIG. 5 illustrates communication of change of access type notification to the IMS and accordingly refers step 106 of FIG. 1 and steps 206, 208 of FIG. 2.

In accordance with the present subject matter, PCF change of access type event is enriched with ISP Identifier parameter for Npcf_EventExposure Service. Change of Access Type event defined in 3GPP Spec TS 29.523 is provided by Npcf_EventExposure Service by PCF and thereafter enriched with ISP identifier in accordance with the present subject matter. Npcf_EventExposure Service of PCF also works on subscribe/notify model as other service-based interfaces (SBI).

PCF observes policy control related to NF (Network Function), which the service consumer has subscribed. PCF thereafter sends an HTTP POST request to the unique resource identifier (URI) with the value previously provided by the NF service consumer within the corresponding subscription.

“PcEventExposureNotif” data structure is used to send event notification using “Npcf_EventExposure_Notify”. The same may be observed from diagrammatic representation in FIG. 5, where “Npcf_EcventExposure” subscription and event notification is shown for change of Access Type notification.

Below tables 3 and 4 illustrate the Notification data structure “PcEventExposureNotif” and “PcEventNotification” that are detailed in 3GPP spec TS 29.523. Data structure “PcEventNotification” for notification is enriched with ISP identifier, so that every time when access type changes to WLAN, is sent to the NF functions as a notification data. ISP identifier may be an optional parameter.

TABLE 3
Definition of type PcEventExposureNotif

| Attribute name | Data type | P | Cardinality | Description |
|---|---|---|---|---|
| Notified | string | M | 1 | Notification Correlation ID |
| | | | | assigned by the NF service |
| | | | | consumer. |
| eventNotifs | array(PcEventNotification) | M | 1 . . . N | Represents the Policy Control |
| | | | | Events to be reported according |
| | | | | to the subscription corresponding |
| | | | | to the Notification Correlation ID. |

TABLE 4
Definition of type PcEventNotification

| Attribute name | Data type | P | Cardinality | Description |
|---|---|---|---|---|
| Event | PcEvent | M | 1 . . . N | Reported Policy Control event. |
| accType | AccessType | C | 0 . . . 1 | Access Type. It shall be included |
| | | | | when the reported PcEvent is |
| | | | | “AC_TY_CH”. |
| addAccessInfo | AdditionalAccessInfo | O | 0 . . . 1 | Indicates the additional |
| | | | | combination of Access Type and |
| | | | | RAT Type available for MA PDU |
| | | | | session. It may be present when |
| | | | | the notified event is “AC_TY_CH” |
| | | | | and the PDU session is a Multi- |
| | | | | Access PDU session. |
| IspIdentifier | String | O | 0 . . . 1 | ISP identifier. It shall be included |
| | | | | when PcEvent is “AC_TY_CH” |
| | | | | and ratType is “WLAN” |
| relAccessInfo | AdditionalAccessInfo | O | 0 . . . 1 | Indicates the release of a |
| | | | | combination of Access Type and |
| | | | | RAT Type available for MA PDU |
| | | | | session. It may be present when |
| | | | | the notified event is “AC_TY_CH” |
| | | | | and the PDU session is a Multi- |
| | | | | Access PDU session. |
| anGwAddr | AnGwAddress | O | 0 . . . 1 | ePDG address. It shall be |
| | | | | included if applicable when the |
| | | | | reported PcEvent is |
| | | | | “AC_TY_CH”. |
| ratType | RatType | O | 0 . . . 1 | RAT Type. It shall be included if |
| | | | | applicable when the reported |
| | | | | PcEvent is “AC_TY_CH”. |
| plmnId | PlmnIdNid | C | 0 . . . 1 | PLMN Identifier and, for an |
| | | | | SNPN, also the NID. It shall be |
| | | | | included when the reported |
| | | | | PcEvent is “PLMN_CH”. |
| Supi | Supi | C | 0 . . . 1 | SUPI of the UE. It shall be |
| | | | | present if available. |
| Gpsi | Gpsi | O | 0 . . . 1 | Gpsi shall contain either an |
| | | | | External Id or an MSISDN. |
| timeStamp | DateTime | M | 1 | Time at which the event is |
| | | | | observed. |
| pduSessInfo | PduSessionInformation | O | 0 . . . 1 | Represents PDU session |
| | | | | information related to the |
| | | | | observed event. |
| repServices | ServiceIdentification | O | 0 . . . 1 | Represents service information |
| | | | | related to the observed event. |

As illustrated within the control flow of FIG. 5, subscription of IMS to PCF's “Change of Access Type” Event Notification has been depicted. At the time of UE registration to IMS(P-CSCF) initiated by UE, IMS sends “Npcf_PolicyAuthorization_Create” request for policy authorization and after that IMS will subscribe to the change of Access Type event notification using PCF's “Npcf_EventExposure_Susbscribe” (3GPP in TS 29.523) request for that UE. When Access Type of UE will be changed to WLAN, then the Access Type change Notification will be generated by PCF and sent to IMS.

In FIG. 5, the step 5 illustrates the “Npcf_EventExposure_Subscribe” request sent from IMS to PCF for subscription to change of access type event notifications at the time of UE registration to IMS. Thereafter, the step 6 shows the “Npcf_EventExposure_Subscribe” response for the request. Step 11 of FIG. 5 shows the change of access type event notification sent from PCF to IMS when access type of UE is changed.

In respect of a real time VoWiFi call reporting to ISP in accordance with the step 108 of FIG. 1, the IMS maintains the Access Type of UE, based on change of access type event notification received from PCF earlier. IMS also accommodates an ISP reporting table about ISP identifier and respective service details of ISP service. IMS initiates a REST request to intimate the ISP for reporting of VoWiFi Calls via operator's internet gateway.

Below table 5 shows the example mapping for the ISP identifier and request reporting service for ISP.

TABLE 5

| | WIFI Internet Service Provider IP |
|---|---|
| ISP Identifier | Address(s) |
| ISP1 | http://VowifiCall.isp1.com/VowifiCall/ |
| ISP2 | http://isp2.com/CallsFromOperator1/ |

On receiving the access type change notification enriched with ISP Identifier from PCF in accordance with FIG. 5, IMS maintains the changed access type of UE. For any voice call during the WLAN access type, the IMS checks for the ISP reporting table (Table 5) against ISP identifier to get the ISP service URL to report the VoWiFi call to the ISP external server. Request to the ISP service URL can be initiated in a secure way using the Mobile Network operator's or the Telecom operator's Internet gateway.

The Telecom operator's Internet gateway may have secure connection using a VPN or similar means. Above interface between ISP and Telecom operator's IMS (Application Function) may be named as Naf3PP. This interface may have fixed parameters as list below:

Naf3PP Operation: Report (Http POST)

| | |
|---|---|
| Parameter | Description |

Request:

| | |
|---|---|
| MSISDN | MSISDN will be sent in the request to the ISP |
| | for VoWiFi Calls. |
| Duration of the Call | Duration of calls will also be reported to the |
| | ISP for VoWiFi Calls. |

Response:

| | |
|---|---|
| Status | Response will only have the status which is |
| | describes the fail/success for the request. |

Overall, the IMS, of the wireless communications system is configured for receiving from a policy control function (PCF) triggered by a request from a User Equipment, UE, a notification for access change that requests transfer of an incoming IMS session established for the UE over a cellular communications access network to an untrusted non-3GPP access network, said notification comprising an internet service provider (ISP) identifier of the untrusted access network. The IMS initiates establishment for the incoming IMS session over the untrusted non-3GPP access network. Thereafter, the IMS reports details related to the one or more mobile originated (MO) or mobile terminated (MT) calls availed by the UE through the untrusted access network to a remote server, said remote server having been located based on the ISP identifier through an internet gateway.

The IMS for reporting details related to the mobile originated (MO) or mobile terminated (MT) calls is configured for maintaining an ISP reporting table comprising a mapping between one or more ISP identifier and one or more addresses of remote servers rendering ISP service. Based on the ISP reporting table and the ISP identifier present in the notification, the IMS tracks an address of the remote server. Thereafter, the IMS initiates a request to the remote server through the internet gateway based on the address for reporting details related to the MO or MT calls.

FIG. 6 illustrates a sequence/call flow diagram in a stepwise manner and accordingly corresponds to the steps 102 to 108 of FIG. 1 and the steps 202 till 208 of FIG. 2.

At step 601 UE is already registered with AMF and 5G core network through 3GPP access, i.e. via 5G Radio access network. At least a purpose of this step is to show that UE has the access to 5G network.

At step 602, once registered to 5G network, UE initiate a SIP registration request to P-CSCF node for IMS.

At step 603, in accordance with the state of the art 3GPP specs, IMS(P-CSCF) sends the Npcf_Policy_Authorization_Create request for authorization and policy association.

At step 604, the PCF performs session binding and identifies corresponding PCC Rules related to IMS Signaling. PCF replies with the confirmation in Npcf_Policy_Authorization_Create response.

At step 605, after receiving the response from PCF for Npcf_Policy_Authorization_Create in above step 704, P-CSCF(IMS) will initiate a Npcf_EventExposure_Subscribe request to subscribe for policy events notifications “Change of Access Type” on a specified context for this UE.

At step 606, the PCF confirms the subscription to notification of access type change and replies to the P-CSCF with an HTTP “201 Created” response.

Steps 601 till 606 collectively corresponds to the steps 102 and 202 of FIG. 1 and FIG. 2, respectively.

At step 607, now due to some network problem, UE connects with Wi-Fi network of an Internet Service Provider ISP (Untrusted Non-3GPP Access) which is registered to the Telecom Operator that UE is a subscriber of.

At step 608, the UE selects a N3IWF node for Untrusted Non-3GPP access and obtained the IP address.

At step 609, after connecting with N3IWF node, UE sends a registration request to the telecom 5G core network.

At step 610, N3WIF checks on the ISP endpoint IP address in the request from UE and tries to find the “ISP Identifier” configured. In this step N3IWF also does the AMF selection for registration.

At step 611, while sending the registration request to AMF via N2 interface, if N3IWF is able to find the ISP in ISP mapping, it will enrich the request with “ISP Identifier” configured in it.

Steps 607 till 611 corresponds to the steps 104 and 204 of FIG. 1 and FIG. 2 respectively.

At step 612, the AMF takes the decision to establish policy association.

At step 613, the AMF sends Npcf_AMPolicyControl_Create request with SUPI, GPSI, Access Type, ISP identifier, etc. The AMF contacts the PCF to create a policy association and retrieve the UE policy and/or Access and mobility control policy.

At step 614, the PCF responds with the policy association information Npcf_AMPolicyControl_Create response.

At step 615, now since UE connects from the untrusted WLAN or WIFI, it encounters the change of access type.

At step 616, since PCF encounters the change of access type of UE from 3GPP access to untrusted non-3GPP access, it triggers a notification event “change of access type” with ISP Identifier parameter in the event towards P-CSCF(IMS) which was previously subscribed to this event at the time of IMS registration. IMS marks it as that the access type of UE is now untrusted WLAN or WiFi.

Steps 612 till 616 correspond to the steps 106 and 206, 208 of FIG. 1 and FIG. 2 respectively.

At step 617, the UE steps up a VoWiFi Call and terminates after the conversation with another party.

At step 618, P-CSCF (IMS) checks for the previously configured ISP service mapping against the ISP identifier sent in the change of access type event from PCF and if found one then move to the next step.

At step 619, after VoWiFi call completion, P-CSCF (IMS) reports the call with details of MSISN and duration to the remote ISP service via a telecom operators internet gateway in a secured way.

Steps 617 till 619 correspond to step 108 of FIG. 1. While the same are described in terms of real time reporting Mobile originated call, the same may be expanded to cover reporting of the Mobile terminated calls as well.

In accordance with aforesaid description, the present subject matter may be appropriated to offers the benefits (discounts & loyalty points) to the Internet users based on real time. In an example, VoWiFi call reporting. Various government telecom authorities of different countries, example telecom regime in any country is very keen on VoWiFi technology and issued recommendations to the telecom operators to rollout to VoWiFi service. The same facilitates making calls in areas with poor cellular connectivity and is more secure than other VOIP 3GPP applications. Also, it can be easily lawfully intercepted if desired by government authorities.

A telecom operator X wants to implement the directive from telecom authorities to promote VoWiFi calling service. Based on real time VoWiFi call reporting in accordance with step 108, ISP can offer some loyalty plans to end users thereby promoting and increasing the user base.

The present subject matter may be appropriated to compares the benefits like discounts and loyalty points being offered by two ISPs, so that the end-user can opt the ISP for making VoWiFi calls. In an example, Airport X is crowded with passengers travelling across the world. Telco X is a major telecom service provider in the country with 5G deployment. Due to lack of telecom X network coverage on airport generally, passengers and staff on the airport use Telco X VoWiFi service using WiFi internet service provided on the airport by two internet service providers (ISP) “ISP A” and “ISP B”. Both the “ISP A” & “ISP B” are untrusted internet WiFi Service providers and has no link with Telco X. Both the ISP offers decent range of internet product for usage.

As a promotion “ISP A” want to tie up with Telco X to offer real time discounts and loyalty points to its prepaid internet usage plan on VoWiFi call rates to its WiFi users for the VoWiFi calls made using Telco X VoWiFi Service. The present subject matter at least renders it feasible in 5G networks and 4G networks by advantageously appropriating the specs in context to Untrusted Non-3GPP access.

In another scenario, the present subject matter help ISP can bring operational efficiency in its network based on the VoWiFi call reporting. For example, “ISP A” is a WiFi Internet Service provider who wants to collect data for internet surfing and usage done by its users for its analysis and reporting purpose. “ISP A” can easily track the Internet usage of the end user but cannot get information if this internet usage consists of number of VoWiFi calls done by the user.

The present subject matter at least renders the following advantage:
Help ISPs in expanding their customer base by offering new plans/dynamics discounts/loyalty points. Also, it will help the mobile network operator in retaining its existing customer base by offering discount to partner ISPs which in turn will benefit the end user.
During the VoWiFi call, ISP details acquired by the proposed solution can be further used by mobile network operator for further analyze and optimizing their RAN(4G/5G).
VoWiFi calls data acquired using present subject matter will help the ISPs in determining the expansion and rollout scope of their footprints in a specific area.
New marketing opportunity and business is rendered for Internet Service Provider and Telecom operators, since they can offer plans and discounts in agreement over VoWiFi calls

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method of operation in a wireless communication system, comprising:
registering by a user equipment (UE) over a cellular communications access network using a session initiation protocol (SIP) registration request with an incoming Internet Protocol Multimedia Subsystem (IMS) session;
triggering by the UE, over an untrusted non-3GPP access network, another IMS registration request along with along with requesting an IP address of the UE, the request comprising an internet service provider (ISP) identifier of the untrusted access network;
transferring by a network node the incoming IMS session to the untrusted access network being accessed by the UE; and
reporting, by the IMS, details of calls availed by the UE through the untrusted access network to a remote server.

2. The method as claimed in claim 1, wherein the registering by the UE with the incoming IMS session comprises:
establishing by a UE over the cellular communications access network, a first Quality of Service QoS flow, for an incoming Internet Protocol Multimedia Subsystem (IMS) session having QoS requirements, wherein the first QoS flow for the incoming IMS session is associated with a first Internet Protocol (IP) address assigned to the UE for the cellular communications access network by the IMS in response to the session initiation protocol (SIP) registration request; and
confirming subscription to a notification of access change by the network node on behalf of the UE based on a subscription request received from the IMS subsequent to the establishment of the first QoS flow for the incoming IMS session.

3. The method as claimed in claim 2, wherein the triggering by the UE another IMS registration request comprises:
receiving a second IP address assigned to the UE for the untrusted access network by an interworking function within the network; and
triggering by the UE, over the untrusted non-3GPP access network, UN-WLAN, access network, a second IMS registration request with the second IP address of the UE.

4. The method as claimed in claim 3, further comprising:
in response to the received second IP address of the UE and the ISP identifier, generating by the network node the access change notification for the IMS for initiating establishment of a second QoS bearer or QoS flow for the incoming IMS session over the untrusted access network, the second QoS bearer or QoS flow for the incoming IMS session being associated with the second IP address assigned to the UE for the untrusted access network.

5. The method as claimed in claim 4, wherein transferring the incoming IMS session to the untrusted access network comprises:
transferring the incoming IMS session from the first IP address of the UE associated with the first QoS bearer or QoS flow established for the incoming IMS session over the cellular communications access network to the second IP address of the UE associated with the second QoS bearer or QoS flow established for the incoming IMS session over the untrusted access network.

6. The method as claimed in claim 1, wherein the reporting by the IMS comprises:
locating the remote server by the IMS based on the ISP identifier through an internet gateway, the remote server corresponding to an internet service provider associated with the untrusted access network; and
reporting details related to one or more mobile originated (MO) or mobile terminated (MT) calls availed by the UE through the untrusted access network to the remote server.

7. The method as claimed in claim 4, wherein initiating establishment of the second QoS bearer or QoS flow for the incoming IMS session over the untrusted access network comprises sending, over the cellular communications access network the SIP message that initiates establishment of the second QoS bearer or QoS flow for the incoming IMS session over the untrusted access network.

8. A method of operation of a user equipment (UE) in a wireless communication system, the method comprising:
registering by a UE over a cellular communications access network using a session initiation protocol (SIP) registration request with an incoming Internet Protocol Multimedia Subsystem (IMS) session;
triggering by the UE, over an untrusted non-3GPP access network, UN-WLAN, access network, another IMS registration request alongside requesting an IP address of the UE, the request comprising an internet service provider (ISP) identifier of the access network;
enabling generation of a notification of an access change by a policy control function (PCF) based on the trigger from the UE, the notification directed to the IMS based on the IP address of the UE and the ISP identifier for initiating establishment of the incoming IMS session over the untrusted access network; and
achieving a transfer of the incoming IMS session from the cellular communications access network to the untrusted access network.

9. The method as claimed in claim 8, wherein registering by the UE with the incoming IMS session comprises:
establishing over the cellular communications access network, a first Quality of Service QoS flow, for an incoming Internet Protocol Multimedia Subsystem (IMS) session having QoS requirements, wherein the first QoS flow for the incoming IMS session is associated with a first Internet Protocol (IP) address assigned to the UE for the cellular communications access network by the IMS in response to the session initiation protocol (SIP) registration request.

10. The method as claimed in claim 8, wherein the triggering by the UE comprises:
receiving a second IP address assigned to the UE for the untrusted access network by an interworking function within the network; and
triggering by the UE, over the untrusted non-3GPP access network, UN-WLAN, access network, an IMS registration request with the second IP address of the UE, the request comprising an internet service provider (ISP) identifier of the access network.

11. The method as claimed in claim 10, wherein the enabling generation comprises:
enabling generation of a notification of an access change by the UE directed to the IMS based on the second IP address of the UE and the ISP identifier for initiating establishment of a second QoS bearer or QoS flow for the incoming IMS session over the untrusted access network, the second QoS bearer or QoS flow for the incoming IMS session being associated with the second IP address assigned to the UE for the untrusted access network.

12. The method as claimed in claim 11, wherein the achieving the transfer of the incoming IMS session comprises:
achieving the transfer of the incoming IMS session from the first IP address of the UE associated with the first QoS bearer or QoS flow established for the incoming IMS session over the cellular communications access network to the second IP address of the UE associated with the second QoS bearer or QoS flow established for the incoming IMS session over the untrusted access network.

13. A method of operation of a network-entity providing a gateway or interworking function between 3GPP network and non-3GPP network in a wireless communications system, the method comprising:
receiving from the UE, over an untrusted non-3GPP access network, UN-WLAN, access network, a connection request;
allocating an IP address to the UE for accessing through the untrusted access network;
receiving from the UE, over the untrusted non-3GPP access network, an IMS registration request from the UE through the IP address, the IMS registration request comprising an internet service provider (ISP) identifier of the untrusted access network; and
sending the IMS registration request to a network node with the ISP Identifier for enabling policy association through the untrusted access network.

14. The method as claimed in claim 13, wherein the interworking function is configured for:
maintaining an ISP table comprising a mapping between one or more ISP IP addresses and one or more ISP identifiers;
identifying the ISP identifier associated with the untrusted access network based on the ISP table; and
sending the IMS registration request to the network node by forwarding the identified ISP identifier to an access and mobility function (AMF) node.

15. The method as claimed in claim 13, further comprising:
enabling creation of a policy association for the access of the UE through the untrusted access network based on a plurality of parameters from UE context and the ISP identifier.

16. The method as claimed in claim 15, wherein the creating of policy association comprises:
updating a set of policy and charging control (PCC) rules for the access of the UE through the untrusted access network with one or more parameters comprising the ISP Identifier and a VoWiFi Call reporting parameter.

17.-36. (canceled)

37. The method as claimed in claim 9, wherein the triggering by the UE comprises:
receiving a second IP address assigned to the UE for the untrusted access network by an interworking function within the network; and
triggering by the UE, over the untrusted non-3GPP access network, UN-WLAN, access network, an IMS registration request with the second IP address of the UE, the request comprising an internet service provider (ISP) identifier of the access network.

38. The method as claimed in claim 37, wherein the enabling generation comprises:
enabling generation of a notification of an access change by the UE directed to the IMS based on the second IP address of the UE and the ISP identifier for initiating establishment of a second QoS bearer or QoS flow for the incoming IMS session over the untrusted access network, the second QoS bearer or QoS flow for the incoming IMS session being associated with the second IP address assigned to the UE for the untrusted access network.

39. The method as claimed in claim 38, wherein the achieving the transfer of the incoming IMS session comprises:
achieving the transfer of the incoming IMS session from the first IP address of the UE associated with the first QoS bearer or QoS flow established for the incoming IMS session over the cellular communications access network to the second IP address of the UE associated with the second QoS bearer or QoS flow established for the incoming IMS session over the untrusted access network.
